(19) United States
(12) Patent Application Publication
(10) Pub. No.: US 2017/0369074 A1
(43) Pub. Date: Dec. 28, 2017

(54) DRIVER ASSISTANCE DEVICE FOR A MOTOR VEHICLE AND METHOD FOR OPERATING THE SAME

(71) Applicant: VALEO Schalter und Sensoren GmbH, Bietigheim-Bissingen (DE)

(72) Inventors: Joachim Mathes, Bietigheim-Bissingen (DE); Martin Moser, Bietigheim-Bissingen (DE); Vsevolod Vovkushevsky, Bietigheim-Bissingen (DE)

(73) Assignee: VALEO Schalter und Sensoren GmbH, Bietigheim-Bissingen (DE)

(21) Appl. No.: 15/536,405

(22) PCT Filed: Dec. 15, 2015
(86) PCT No.: PCT/EP2015/079710

§ 371 Date: Jun. 15, 2017

(30) Foreign Application Priority Data
Dec. 17, 2014 (DE) 102014018913.9

(51) Int. Cl. B60W 50/00; B60W 30/12; B60W 40/04; B60W 40/09; B60W 30/16

(52) U.S. Cl. CPC B60W 50/0098; B60W 40/09; B60W 30/162; B60W 40/04; B60W 30/12; B60W 2050/0089; B60W 2550/141; B60W 2550/402

(57) ABSTRACT

The invention relates to a method for operating a driver assistance device of a motor vehicle, comprising detection of an area surrounding the motor vehicle by a sensor device of the motor vehicle, which sensor device is associated with the driver assistance device, detection of at least one action by a driver of the motor vehicle, which action is related to a driving movement of the motor vehicle, by a further sensor device of the motor vehicle, which further sensor device is associated with the driver assistance device; learning of a correlation between the detected surrounding area and the detected action by the driver assistance device by means of repeated detection of the surrounding area and the action, evaluation of a degree of reliability of the learnt correlation by means of a quality measure by the driver assistance device, and implementation of at least one automated function, which is related to a driving movement of the motor vehicle, by the driver assistance device depending on the current area surrounding the motor vehicle and/or a value of the quality measure in order to provide a driver of the motor vehicle with surrounding area-dependent assistance by a driver assistance device as quickly as possible.

The invention relates to a method for operating a driver assistance device of a motor vehicle. It also relates to a driver assistance device for a motor vehicle according to the preamble of Patent Claim 8.

Driver assistance devices or driver assistance systems which partially or completely relieve a driver of driving tasks are known. This may be the case, for example, during a manoeuvring operation, such as parking, or driving on a motorway. These driver assistance devices are reliant on having available a sufficient quantity of information about an area surrounding the vehicle and the driving situation for the purpose of taking over driving tasks of the said kind. Since this information cannot always be detected by an existing sensor system with, often, a whole range of sensor devices, driver assistance devices which have a learning mode are provided. In a learning mode of this kind, a driver assistance device of this kind detects actions by the driver and also an area surrounding the motor vehicle and in this way generates a sufficient database for automating driving tasks. Since a learning process of this kind can take a relatively long time, it is the case that the associated automated function is not available over a long period of time or is not available at all.

By way of example, DE 10 2011 107 974 A1 discloses a method for manoeuvring a vehicle in an environment. In this case, the vehicle is controlled by the driver in a reference manoeuvring process in a learning mode. The reference manoeuvring process is stored and, after the learning mode, taken into account by the vehicle in the case of repeated manoeuvring, which is to be implemented at least semi-autonomously, in the same environment.

DE 10 2010 023 162 A1 describes a method for assisting a driver of a motor vehicle when driving into a parking space with the aid of a driver assistance device. In this case, reference data about a surrounding region of the parking space is detected with the aid of a sensor device and stored in a learning mode of the driver assistance device, with the motor vehicle being driven into the parking space in a manner controlled by the driver. In a subsequent operating mode of the driver assistance device, which operating mode is different from the learning mode, sensor data is detected by the sensor device and compared with the reference data. Depending on this comparison, the surrounding region of the parking space is identified on the basis of the detected sensor data and in this way a current position of the motor vehicle relative to a reference position of the motor vehicle, which reference position was assumed in the learning mode, is determined. Finally, a parking path along which the motor vehicle is driven into the parking space from the current position is defined by the driver assistance device depending on the current position of the motor vehicle relative to the reference target position.

The object of the present invention is to provide a driver of a motor vehicle with surrounding area-dependent assistance by a driver assistance device, in particular in a known surrounding area, that is to say in a surrounding area which has been driven in before, as quickly as possible. In particular, the assistance operation is to take into account a driver preference and/or habit.

This object is achieved by the subjects of the two independent patent claims. Advantageous embodiments can be gathered from the dependent patent claims, the description and the figures.

A method according to the invention for operating a driver assistance device or a driver assistance system of a motor vehicle comprises a series of steps. One step is detection of an area surrounding the motor vehicle by a sensor device of the motor vehicle, which sensor device is associated with the driver assistance device. Furthermore, detection of at least one action by a driver of the motor vehicle, which action is related to a driving movement of the motor vehicle, by a further sensor device of the motor vehicle, which further sensor device is associated with the driver assistance device, is also part of the method. In a further step, learning of a correlation between the detected surrounding area and the detected action by the driver assistance device by means of repeated detection of the surrounding area and the action is performed. Learning can therefore take place consecutively or continuously. Evaluation of a degree of reliability of the learnt correlation by means of a quality measure by the driver assistance device is also performed. The degree of reliability of the learnt correlation can therefore be quantified by the quality measure. The quality measure can therefore describe a level of confidence for the data on which the correlation is based. Finally, implementation of at least one automated function, which is related to a driving movement of the motor vehicle, by the driver assistance device depending on the current area surrounding the motor vehicle and/or a value of the quality measure is performed.

This has the advantage that the automated function, in particular a degree of automation of the automated function, can be matched to the quality or degree of reliability of the learnt correlation. Therefore, a risk to the automated function, which risk is created by a lack of reliability of the learnt correlation, can be precluded and the use of the automated function can be at least gradually provided to the driver of the motor vehicle as quickly as possible. Therefore, the data which has been collected to date or the correlation which has been learnt to date can always be used in an optimum manner for the benefit of the driver.

In a preferred embodiment, it is provided that a frequency of the detection of the surrounding area and the action and/or a degree of up-to-dateness of the detection of the surrounding area and the action is taken into account by the quality measure. In this case, a greater frequency and/or a greater degree of up-to-dateness corresponds to a quality measure which represents a greater degree of reliability. Detected data relating to the surrounding area and the action, and therefore correlations which have only recently been confirmed, for example on the previous day, accordingly have a higher level of confidence or a greater degree of reliability than data or a correlation which has been left without confirmation over a relatively long time. Even if the driver does not carry out the manoeuvre or the action which is related to a driving movement of the motor vehicle and which forms the basis for the correlation for long, or the currently detected action differs considerably from previously detected actions in a specific surrounding area, the degree of reliability of the corresponding correlation can be reduced. By means of a learning algorithm used, detected data can also no longer be taken into account for learning the correlation after a specific time or detected data which is detected only once and then no longer confirmed can be rejected for a learnt correlation. This has the advantage that the degree of reliability of the learnt correlation is represented particularly accurately by the quality measure. Changes in a behaviour of the driver can therefore also quickly become apparent when evaluating the degree of reliability.

In a particularly preferred embodiment, it is provided that, for the purpose of implementing the automated function, categorization of the current area surrounding the motor vehicle and/or of the quality measure of the learnt correlation is performed, specifically in discrete categorization stages, and the automated function comprises different subfunctions depending on the categorization stage. This has the advantage that firstly the functionality of the corresponding subfunctions of the automatic function can be made available to the driver quickly and secondly safety buffers in the form of minimum requirements of the categorization stage and therefore the degree of reliability of the learnt correlation for specific prespecified subfunctions can accordingly be realized at the same time.

In this case, it can be provided that, in a first categorization stage which is selected, in particular, for an area surrounding the motor vehicle which is detected for the first time, the automated function, as subfunction, comprises only at least one function of the driver assistance device which can be used without learning, in particular warning a driver based on a current detection of the surrounding area. This has the advantage that the driver assistance device in an unknown surrounding area, in which obviously no correlation could be learnt, cannot be distinguished by the driver from a customary driver assistance device without the above-described ability to learn a correlation. At the same time, learning of a correlation takes place, so that, in the event of a repeated movement of the motor vehicle in this surrounding area, the driver assistance device can provide improved assistance to the driver.

Furthermore, it can be provided here that, in a second categorization stage which is selected, in particular, for an area surrounding the motor vehicle which has been detected at least once before with prespecified first values of the quality measure, the automated function, as subfunction, outputs at least one surrounding area-specific recommendation to the driver. This recommendation may be, in particular, a steering torque which is supplied to a steering wheel of the motor vehicle by the driver assistance device and/or a visual or haptic recommendation of a steering angle and/or a visual or haptic recommendation of a throttle position and/or a visual or haptic recommendation of a clutch position and/or a visual or haptic recommendation of a gear selection. In particular, the prespecified first values of the quality measure represent a low degree of reliability or level of confidence here. This has the advantage that the driver can already profit from the learnt correlations very quickly, after a short learning process, but in the process a possibly low degree of reliability of the learnt correlations and therefore a possibly unsuitable or incorrect interpretation of a situation by the driver assistance device does not create any danger since the driver only receives a recommendation. Here, the vehicle is still controlled by the driver and is accordingly safe.

Furthermore, it can be provided here that, in a third categorization stage which is selected, in particular, for an area surrounding the motor vehicle which has been detected at least once before with prespecified second values of the quality measure, the automated function, as subfunction, comprises at least one partially autonomous control operation of the motor vehicle by the driver assistance device with direct monitoring by the driver, that is to say when said driver is sitting in the motor vehicle for example. Direct monitoring can be ensured, for example, by the driver not being allowed to take his hands off the steering wheel during the partially autonomous control operation or removal of the hands from the steering wheel resulting in an interruption in the partially autonomous control operation of the motor vehicle. In particular, the subfunction comprises a partially autonomous lateral control operation and/or a partially autonomous longitudinal control operation of the motor vehicle by the driver assistance device. The prespecified second values of the quality measure can represent a high level of confidence or a high degree of reliability of the correlation here. Here, the prespecified second values of the quality measure preferably lie above first values which are prespecified for the second categorization stage. This has the advantage that the driver can once again quickly profit from the learnt correlations but safety is not put at risk in the process at the same time since the driver monitors the subfunction.

Finally, it can be provided here that, in a fourth categorization stage which is selected, in particular, for an area surrounding the motor vehicle which has been detected at least once before with prespecified third values of the quality measure, the automated function, as subfunction, comprises at least one autonomous control operation of the motor vehicle by the driver assistance device without direct monitoring by the driver. In particular, the subfunction can comprise an autonomous lateral control operation and/or an autonomous longitudinal control operation of the motor vehicle by the driver assistance device and/or an autonomous operation for driving the motor vehicle into and/or out of a parking space. Here, the driver can leave the motor vehicle. Here, the third values of the quality measure represent a very high level of confidence or a very high degree of reliability of the correlation. The prespecified third values of the quality measure preferably improve on the prespecified second values. This has the advantage that the driver therefore receives full, surrounding area-specific assistance by the driver assistance device.

An embodiment in which the said four categorization stages are jointly realized is particularly preferred here.

Here, learning of the correlations further takes place, in particular, in each of the said categorization stages.

The invention also relates to a driver assistance device for a motor vehicle, comprising a sensor device for detecting an area surrounding the motor vehicle and comprising a further sensor device for detecting at least one action by a driver of the motor vehicle, which action is related to a driving movement of the motor vehicle. It is essential here that the driver assistance device also comprises a learning unit for learning a correlation between the detected surrounding area and the detected action. This learning is performed by means of repeated detection of the surrounding area, that is to say the same surrounding area in each case, and the action by the driver which is detected in this same surrounding area. In the process, a degree of reliability of the learnt correlation by means of a quality measure can be evaluated by means of an evaluation device of the driver assistance device. At least one automated function, which is related to a driving movement of the motor vehicle, can also be implemented by means of the driver assistance device depending on the current area surrounding the motor vehicle and/or a value of the quality measure. The automated function can also always be dependent on the current surrounding area and additionally optionally on a value of the quality measure. Advantages and advantageous embodiments correspond here to the advantages and advantageous embodiments of the corresponding method.

Further advantages, features and details of the invention can be gathered from the following description of preferred exemplary embodiments. The features and combinations of features cited above in the description and the features and combinations of features cited below in the description of the exemplary embodiments can be used both in the respectively indicated combinations and also in other combinations or on their own, without departing from the scope of the invention.

In a first exemplary embodiment of the method, learning by the driver assistance device is implemented when the motor vehicle is in the vicinity of a favoured parking area, for example in the vicinity of a parking area at home or in the vicinity of a parking area at a workplace. Here, the driver assistance device then detects the respective surrounding area and the parking actions implemented by a driver. As the number of detected parking actions increases and detection of the area surrounding the corresponding parking area is repeated, it is possible to distinguish between stationary and mobile obstacles. The driver assistance device can also learn which section of a free space of the corresponding parking area the driver actually uses when parking and which target position of the motor vehicle is favoured by the driver.

In this example, categorization of the detected data, that is to say the detected surrounding area and a detected action by the driver, into four discrete categorization stages, which each result in an automated function with a different functional scope, is performed for the purpose of carrying out an automated function which is related to a driving movement of the motor vehicle.

In the first categorization stage, in the present case in an unknown surrounding area which is detected for the first time, the driver assistance device generates, for example, warnings on the basis of the sensor data, that is to say on the basis of the detected surrounding area, as is known from a conventional parking aid. In a second categorization stage which is achieved when the surrounding area is known, that is to say has already been detected before, but only a few or very different actions by the driver have been detected in this surrounding area, so that a learnt correlation between the surrounding area and a driver action has a low degree of reliability or a low level of confidence, the driver assistance device recommends a favourable trajectory for the process of driving into or out of a parking space to the driver in the present case. Here, the driver assistance device can, for example, apply an additional steering torque on a steering wheel of the motor vehicle and/or reduce a speed of the motor vehicle. In a third categorization stage, in which the current surrounding area has already been detected several times and the correlation between a surrounding area and an action by a driver learnt there has a high level of confidence or a high degree of reliability, the driver assistance device in this case offers the driver a fully automated parking process which has to be monitored by the driver. This monitoring can be performed, for example, by operating a dead man's switch. The fourth categorization stage, in which a correlation has been learnt for a known surrounding area with a very high level of confidence or a very high degree of reliability, the driver assistance device can park the motor vehicle in a fully automatic manner in this example, without the driver having to monitor the process or without the driver having to be in the motor vehicle.

In a further exemplary embodiment of the method for operating a driver assistance device of a motor vehicle, driving on developed roads can be automated. Here, the driver activates, for example, a learning mode, that is to say learning by the driver assistance device after he has driven his vehicle onto a preferred stretch of road. The learning mode can also be automatically activated. During learning, the driver assistance device collects information about the road section and the driving style of the driver by detecting the surrounding area and the actions by the driver. This information can also be compared with navigation data. Therefore, a correlation relating to the road section and the driving style of the driver is learnt by means of the learning operation. The more often this learning is implemented, that is to say the more learning processes are completed, the greater the value of the quality measure for the degree of reliability of the learnt correlation in the present case. Accordingly, a relatively high automation stage can be offered to the driver by the driver assistance device for a relatively high degree of reliability.

In the present example, the four categorization stages, as are known from the example outlined above, can be linked with, for example, the same fundamental requirements in respect of a degree of knowledge about the surrounding area and a degree of reliability of the correlations, but comprise other automated subfunctions of the automated function. Therefore, in the case of an unknown surrounding area, a warning, for example, can be output by the driver assitance device in the first categorization stage when the motor vehicle leaves a lane, remains at an obstacle at a dead angle or the like, as is known from the driver assistance devices in the prior art. In the second categorization stage in a known surrounding area with a correlation with a low degree of reliability, a steering or throttle recommendation can be made, for example, by the driver assistance device, wherein the driver controls the motor vehicle as before. In the third categorization stage in a known surrounding area with a correlation with a high degree of reliability, automated driving of the motor vehicle by the driver assistance device can be performed here, wherein the driver monitors the process, for example by means of his hands remaining on the steering wheel. In the fourth categorization stage, in the case of a known surrounding area with a very high degree of reliability of the learnt correlation, the driver assistance device can offer fully automated driving in the present case. In this case, the driver does not have to monitor the process and can, for example, instead work, read a newspaper or occupy himself in some other way.

1. A method for operating a driver assistance device of a motor vehicle, comprising:
detecting an area surrounding the motor vehicle by a sensor device of the motor vehicle, which sensor device is associated with the driver assistance device,
detecting at least one action by a driver of the motor vehicle, which action is related to a driving movement of the motor vehicle, by a further sensor device of the motor vehicle, which further sensor device is associated with the driver assistance device;
learning of a correlation between the detected surrounding area and the detected action by the driver assistance device by means of repeated detection of the surrounding area and the action;
evaluating of a degree of reliability of the learnt correlation by means of a quality measure by the driver assistance device; and
implementing of at least one automated function, which is related to a driving movement of the motor vehicle, by the driver assistance device depending on the current area surrounding the motor vehicle and/or a value of the quality measure.

2. The method according to claim 1, wherein a frequency of the detection of the surrounding area and the action and/or a degree of up-to-dateness of the detection of the surrounding area and of the action is taken into account by the quality measure, and a greater frequency and/or a greater degree of up-to-dateness corresponds to a quality measure which represents a greater degree of reliability.

3. The method according to claim 1, wherein, for the purpose of implementing the automated function, categorization of the current area surrounding the motor vehicle and/or of the quality measure of the learnt correlation is performed, specifically into discrete categorization stages, and the automated function comprises different subfunctions depending on the categorization stage.

4. The method according to claim 3, wherein, in a first categorization stage which is selected, for an area surrounding the motor vehicle which is detected for the first time, the automated function, as subfunction, comprises at least one function of the driver assistance device which can be used without learning, in particular warning the driver based on a current detection of the surrounding area.

5. The method according to claim 3, wherein, in a second categorization stage which is selected, in particular, for an area surrounding the motor vehicle which has been detected at least once before with prespecified first values of the quality measure, the automated function, as subfunction, outputs at least one surrounding area-specific recommendation to the driver, a steering torque and/or a recommendation of a steering angle and/or a recommendation of a throttle position and/or a recommendation of a clutch position and/or a recommendation of a gear selection.

6. The method according to claim 3, wherein, in a third categorization stage which is selected, in particular, for an area surrounding the motor vehicle which has been detected at least once before with prespecified second values of the quality measure, the automated function, as subfunction, comprises at least one partially autonomous control operation of the motor vehicle by the driver assistance device with direct monitoring by the driver, a partially autonomous lateral control operation and/or a partially autonomous longitudinal control operation of the motor vehicle by the driver assistance device.

7. The method according to claim 3, wherein, in a fourth categorization stage which is selected, for an area surrounding the motor vehicle which has been detected at least once before with prespecified third values of the quality measure, the automated function, as subfunction, comprises at least one autonomous control operation of the motor vehicle by the driver assistance device without direct monitoring by the driver, an autonomous lateral control operation and/or an autonomous longitudinal control operation of the motor vehicle by the driver assistance device or an autonomous operation for driving into and/or out of a parking space.

8. driver assistance device for a motor vehicle, comprising:
a sensor device for detecting an area surrounding the motor vehicle;
a further sensor device for detecting at least one action by a driver of the motor vehicle, which action is related to a driving movement of the motor vehicle; and
a learning unit for learning a correlation between the detected surrounding area and the detected action by means of repeated detection of the surrounding area and the action,
wherein a degree of reliability of the learnt correlation by a quality measure is evaluated by an evaluation device of the driver assistance device,
wherein at least one automated function, which is related to a driving movement of the motor vehicle, is implemented by the driver assistance device depending on the current area surrounding the motor vehicle and/or a value of the quality measure.
